(19) United States
(12) Patent Application Publication
(10) Pub. No.: US 2016/0343229 A1
(43) Pub. Date: Nov. 24, 2016

(54) VIGILANCE DETECTION METHOD AND APPARATUS

(71) Applicants: George Martin Hutchinson, San Antonio, TX (US); Frank Colony, Gig Harbor, WA (US)

(72) Inventors: George Martin Hutchinson, San Antonio, TX (US); Frank Colony, Gig Harbor, WA (US)

(73) Assignees: Frank Colony, Gig Harbor, WA (US); George Martin Hutchinson, San Antonio, TX (US)

(21) Appl. No.: 14/715,512

(22) Filed: May 18, 2015

(51) Int. Cl. G08B 21/06; G06K 9/00

(52) U.S. Cl. CPC G08B 21/06; G06K 9/00617

(57) ABSTRACT

An apparatus and method for calculating a real-time cognitive capacity score based on physical measurements of a user operating in a mentally fatiguing environment is provided. The cognitive capacity score is based primarily on measurements of various eye-blink variables, supported by other objective and subjective measures.

### CROSS-REFERENCE TO RELATED APPLICATIONS

This application claims priority to U.S. Provisional Application Ser. No. 62/006282, filed Jun. 2, 2014, entitled “Vigilance Detection Method And Apparatus”, the contents of which is incorporated herein in its entirety by this reference.

### BACKGROUND OF INVENTION

1. Field of the Invention

The present invention relates in general to the field of cognitive fatigue monitoring in situ.

2. Description of Related Art

Fatigue has risen to an exceptional level of concern for persons involved in critical occupations such as transportation system operators, medical workers, and other “human interface” occupations where other innocent persons lives are at stake. Those operators who directly control transportation apparatus or manually interface with dangerous equipment, are in a position to injure or kill one or more other persons through their actions, and are at risk of not knowing their own mental or physical state while performing those tasks. Pilots, for example, fly airplanes which are mechanically sound directly into the ground (CFIT or controlled flight into terrain) specifically because they are tired or fatigued and don't know it. Physicians amputate the wrong leg or leave instruments inside patients after operations, not because they don't have procedures to prevent such horrors, but because they are too tired to follow them.

It has long been established that persons who are in a fatigued mental state are least able to recognize their own level of fatigue. NASA has done many studies proving that tired people don't think that they are “that tired” and they may actually argue with another who points this out. Companies who employ these workers are trying to maximize output at the lowest possible cost. They may force any potential liability onto the employee as to their physical or mental state when they perform said activities. Airlines actually fought with the FAA as they were trying to implement new work and rest policies saying that they were far too costly. The FAA conceded somewhat to this argument and has excluded cargo operators from the new stringent policies adopted in 2013. This does not resolve the problem of fatigue, however.

There is currently no method for measuring, in a statistically verifiable way, the level of fatigue in an individual. There are rest profiles and circadian tracking methods existing but they are subjective and not verifiable. Just because one individual should be fatigued given a specific set of rest/work conditions does not, in fact, guarantee that he or she is actually fatigued. One set of conditions does not necessarily repeat the same outcome the next time these conditions exist. For the employee (operator) to self identify and then back up his or her condition with evidence is usually only possible with some sort of work proof ie: an error or accident. This is costly both in terms of employee output and ultimately human life. A means needs to be developed where an actual measurement can be made which is statistically verifiable and that proves fatigue in an individual. This would be beneficial both for the operator (employee) and the employer as it could be used to remove and replace the operator prior to a critical mistake.

### BRIEF SUMMARY OF THE INVENTION

The present application discloses an apparatus and a method to detect and alert for alterations in vigilance of a human subject. The apparatus comprises an optical device to obtain a sequence of images of an eye and a facial region around the eye and a processor connected to the optical device. The optical device may be a camera. Connected like this, the processor is able to process sequences of images received from the optical device. The processor analyzes these images for indications of a blink of the eye using various cues, determining periods when the eye is open, is closed, or is partially open. From these measured periods, the processor can then determine the rate of closure, from open to closed, of the eye blink. The rate of closure calculation may be performed at a time when the subject is alert and the processor may store this value associated with this subject for future comparison. The apparatus may also obtain a rate of closure measurement in a similar manner during an activity of possible compromised vigilance or alertness. The processor may then perform a comparison between the previously stored rate of closure value obtained when the subject was alert and a rate of closure obtained during the activity of possible compromised vigilance or alertness. Upon detecting a sufficient difference between these two rate of closure values, the processor communicates to an alert system that may provide an audible, visual, or haptic indication of this condition. The difference between the two rates of closure indicates an increase in mental fatigue, a decrease in cognitive performance, or other cognitive impairments.

The apparatus may also comprise a user input device in data communication with the processor. Upon an alert indicating a decrease in vigilance or other cognitive impairment, the user input device may be employed by the subject to convey a correction to the processor regarding his actual self-assessed state of vigilance. The processor may utilize the correction in a subsequent comparison. The processor may utilize the correction to reestablish a new alert rate of closure value.

As used herein, unless otherwise indicated, “or” does not require mutual exclusivity. The use of the word “a” or “an” when used in conjunction with the term “comprising” may mean “one,” but it is also consistent with the meaning of “one or more,” “at least one,” and “one or more than one.”

In the following description, numerous details are set forth to provide a more thorough explanation of embodiments of the present invention. It will be apparent, however, to one skilled in the art, that embodiments of the present invention may be practiced without these specific details.

These and other aspects of the devices of the invention are described in the figures, description and claims that follow.

### BRIEF DESCRIPTION OF THE SEVERAL VIEWS OF THE DRAWING

FIG. 1 shows a cognitive capacity detection apparatus according to an embodiment of the invention;

FIG. 2 shows a detailed view of an optical device or camera of the cognitive capacity detection apparatus of FIG. 1;

FIG. 3 shows the cognitive capacity detection apparatus according to an embodiment of the invention; and

FIG. 4 shows a method for detecting vigilance according to an embodiment of the invention.

### DETAILED DESCRIPTION OF THE INVENTION

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description and all changes that come within the meaning and range of equivalency of the claims are therefore intended to be embraced therein.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

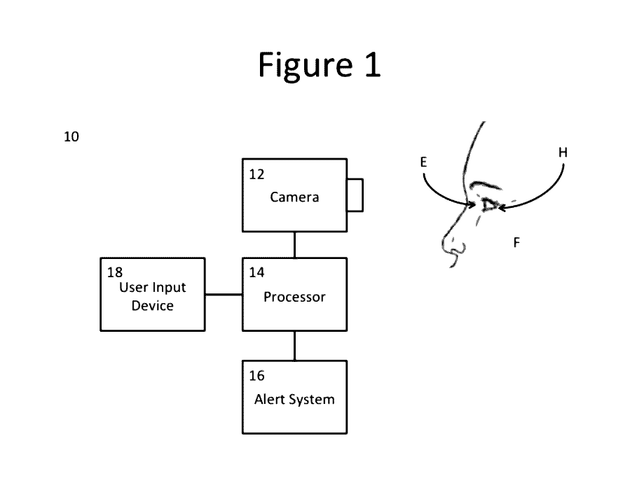

Referring to FIG. 1, a cognitive capacity detection apparatus 10 sometimes referred to as a vigilance detection system comprises an optical device 12 in data communication with a processor 14. The optical device 12 is configured to acquire a sequence of images of an eye E and a facial region F of a subject, the facial region F being proximate the eye E. The sequence of images is communicated to the processor 14, the processor 14 being adapted to measure of a set of attributes of the eye E and the facial region F. The processor 14 is further configured to analyze the set of attributes to obtain a vigilance score for the subject. The processor 14 is in data communication with an alert system 16, the alert system 12 configured to provide a visual, an audible, or a haptic alert when the processor 14 obtains a vigilance score for the subject that indicates a loss of cognitive capacity including but not limited to a loss of vigilance, a decrease in mental capacity, or an increase in mental fatigue. The cognitive capacity detection apparatus 10 also may comprise a user input device 18 in data communication with the processor 14. The cognitive capacity detection apparatus 10 may also comprise a light source oriented to illuminate the eye E or the facial region F. Light from the light source may facilitate the acquisition of images of the eye E or the facial region F by the optic device 12.

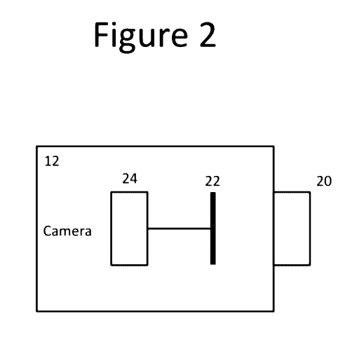

Referring now to FIG. 2, the optical device 12 comprises a lens 20, a sensor 22, and a sensor processor 24. As the lens 20 of the optical device 12 is directed towards the eye E and the facial region F, an image of the eye E and the facial region F impinges the sensor 22 and a digital representation of the image is then captured by sensor processor 24. The sensor processor 24 detects light in visible, infrared, or ultraviolet spectrum ranges or a combination of two or more of these spectra. The image may be buffered to send to processor 14 as subsequent images are captured by the optical device 12 in a similar manner. During the time that the cognitive capacity detection apparatus 10 is activated, the sequence of images will be obtained by the optical device 12 and passed to processor 14.

The processor 14 is adapted to analyze each image of the eye E and facial region F for characteristics that indicate whether the eye E is open, is closed, or is partially open in order to determine the duration of an eye open phase, an eye close phase, and an eye blink phase known respectively as an eye open period, an eye closed period and an eye blink period. These characteristics may include a fraction of a black pupil of the eye E, a fraction of a colored iris of the eye E, a fraction of a white sclera of the eye E, a contrast score of a set of skin folds of the facial region F (known in the vernacular as “smile lines” or “crow's feet”), a contrast score of eye lid hairs H of the facial region F, or other related characteristics. The fraction of the black pupil provides an indicator of a fully open or fully closed eye by determining the roundness of a black or nearly black ovoid within the eye E. When the black ovoid within the eye E matches a round template, the eye E is scored as open and when the black ovoid with the eye E is not present, the eye E is scored as closed. At other times, the eye E is scored as partially closed. Similarly, given that the eye E is open for longer periods than it is partially closed during a blink, the fraction of white sclera of the eye E associated with an open state can be estimated from an amount viewed by the optical device 12 over long periods. When the fraction of the white sclera of eye E is not visible to the optical device 12, the eye E is scored as closed. At times when the fraction of the white sclera of eye E is less than the amount associated with the open state but is not in the closed state, the eye E is scored as partially closed, in a blink.

Use of contrast is known in the art of digital photography as a mechanism to set an autofocus. Defining a high contrast edge as indicative of being in focus is commonly used in digital camera systems. Novelly, this approach can be applied to determine the open or the closed state of the eye E. When the eye E is in the closed state, the eye lid hairs H of the top lid and the bottom lid would be together or meshed and when the eye E is in the open state, the eye lid hairs H of the top lid and the bottom lid would be separated. When the eyelid hairs H of the top lid and the bottom lid are neither fully separated nor fully meshed, the eye E is scored as partially closed, in a blink.

The cognitive capacity detection apparatus 10 is envisioned to be used in any environment in which human operation of a device or system requires vigilance for safe and effective operation. By way of illustrative, non-limiting examples, the cognitive capacity detection apparatus 10 may be employed in a cockpit of an airplane or a cab of a commercial truck. In the situation of the cockpit of the airplane, the cognitive capacity detection apparatus 10 may be affixed to an instrument panel of the cockpit and oriented with the lens 20 of the optical device 12 directed generally towards the eye E of the subject in which the subject is a pilot. A description of the airplane cockpit instrument panel is found in FAA publication “Aviation Maintenance Technician Airframe Handbook” (2012). Affixed as described, the cognitive capacity detection apparatus 10 is oriented to monitor the eye E and the facial region F of the pilot and to provide an indication of cognitive capacity by way of the alert system 16. In a similar manner, in the environment of the cab of the commercial truck, the cognitive capacity detection apparatus 10 may be affixed to a portion of a dashboard of the commercial truck, the lens 20 of the optical device 12 directed generally towards the eye E and facial region of the subject, in this case, a driver.

In an embodiment, the cognitive capacity detection apparatus 10 further comprises an accelerometer 26 in data communication with the processor 14 and configured to be removably affixed to the head of the subject. When the subject's head bobs or flinches with fatigues, the accelerometer 26 registers this movement, subsequently communicating with the processor 14. The processor 14 then algorithmically combines this movement indication with the rate of eye closure or the open-to-close ratio or both the rate of eye closure and the open-to-close ratio to generate a cognitive capacity score whereby a measurement of head bobbing or jerking that is associated with sudden onset of sleep supports a more extreme cognitive capacity score.

In another embodiment, the cognitive capacity detection apparatus 10 further comprises a self-scoring system for mental fatigue. The cognitive capacity detection apparatus 10 is configured to present a series of inquiries to the user via the user input device 18 that are related to factors that may affect cognitive capacity. They include one or more of the following: number of time zone shifts encountered in the previous three days; number of hours of total sleep in the last three days; longest period of sleep in the last three days; number of duty hours in the last three days. Other variables may be included in this inquiry. In operation, upon initiating the operating phase, the cognitive capacity detection apparatus 10 is configured to present the series of inquiries and the user responds appropriately to the series of inquiries. The processor 14 then generates a self-scoring index of potential fatigue based on the responses to the series of inquiries. The self-scoring index of potential fatigue is then combined algorithmically within the processor 14 with the operating cognitive capacity score whereby a higher index of potential fatigue increases the effects that the rate of eye closure and the open-to-closed ratio have on the cognitive capacity score.

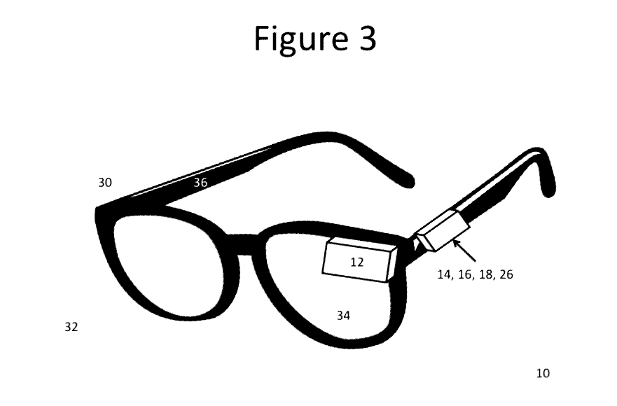

Referring now to FIG. 3, the cognitive capacity detection apparatus 10 is shown according to an alternate embodiment of the invention. The optic device 12 is affixed to a frame 30 of eyewear 32, oriented proximate a lens 34 of the eyewear 32 and positioned such that the lens 34 of the optic device 12 is directed towards the eye E of the user. The processor 14 is affixed to an arm 36 of the frame 30 of the eyewear 32 positioned either proximate a temple of the user or an ear of the user or at a point between the ear and the temple of the user. Physically contiguous with the processor 14 is the alert system 16, the user input device 18, and the accelerometer 26. Each of the optic device 12, the alert system 16, the user input device 18, and the accelerometer 26 are in data communication with the processor 14. In this manner, the optic device 12 is positioned to provide images of the eye E, the colored iris, the pupil, the white sclera, the facial region F, the skin folds of the facial region F, the eye lid hairs of the facial region F, or other related characteristics. From these elements, the operating cognitive capacity score is determined by the processor 14, whether augmented by data from the accelerometer 26, the self-scoring index, both, or neither. In an embodiment, the alert system 16 is configured to project an image alert indicating the cognitive capacity score or other measures of mental fatigue of the user onto the user-facing side of the lens 34. The alert system 16, even when projecting information onto the lens 34, may still generate audible or haptic alerts to augment the image alert.

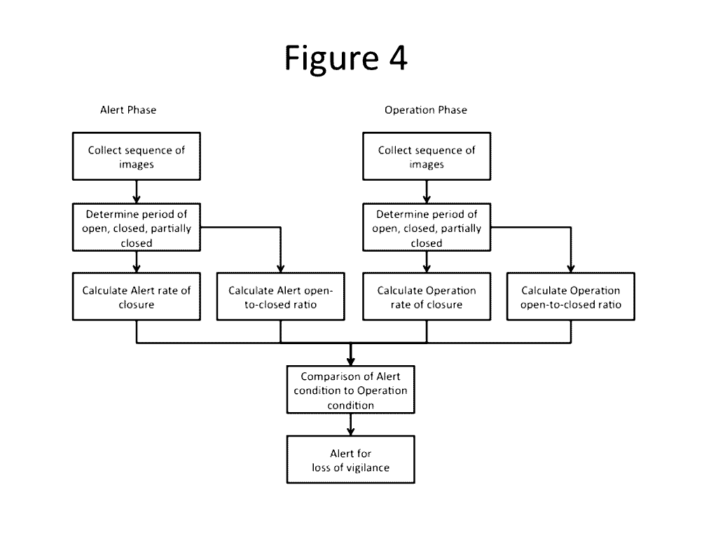

Referring now to FIG. 4, the cognitive capacity detection apparatus 10 in use is described. While the subject is in an alert phase in which the subject is considered to be well-rested and mentally focused, for instance an hour after an eight hour sleep period, the cognitive capacity detection apparatus 10 is utilized to collect a sequence of images of the eye E and the facial region F of the subject. The collection of the sequence of images is initiated using the user input device 18. The cognitive capacity detection apparatus 10 may be operated by the subject on himself or may be operated by a second party on the subject. The sequence of images is gathered over a test period of between about one minute and about 60 minutes, preferably between about three minutes and about five minutes.

The cognitive capacity detection apparatus 10 processes the sequence of images as previously described herein, delineating a series of eye open phases, eye blink phases, and eye closed phases. From these phases, the cognitive capacity detection apparatus 10 determines a series of eye open periods, eye blink periods, and eye closed periods. Utilizing a calculation of central tendency, a representative score of eye open periods, eye blink periods, and eye closed periods is calculated. From these three scores, the eye open score, the eye blink score, and the eye closed score, the cognitive capacity detection apparatus 10 further calculates a rate of eye closure and an open-to-closed ratio. The rate of eye closure is calculated simply as the eye blink period, or time that is taken for the eye E to transition from an open state to a closed state and is expressed in units of milliseconds per blink. The open-to-closed ratio is calculated as the ratio of the eye open score to the eye closed score and is a unitless variable. The rate of eye closure and the open-to-close ratio are used alone or in combination to develop a rested cognitive capacity score, which is generally proportional to the user's level of mental fatigue, the greater the mental fatigue, the lower the cognitive capacity score. Using the user input device 18, these scores and calculations are associated with the subject having been evaluated and are electronically stored in the cognitive capacity detection apparatus 10. This procedure may be repeated for other subjects and correspondingly electronically stored in the cognitive capacity detection apparatus 10.

The rested cognitive capacity score of the user is electronically stored in the cognitive capacity detection apparatus 10 for a future comparison to other cognitive capacity scores from the same user. In an embodiment, the cognitive capacity detection apparatus 10 electronically stores a rested cognitive capacity score from a plurality of users, each stored in a manner associated with a unique identifier for the user.

Upon entering an operation phase, the cognitive capacity detection apparatus 10 may be affixed within the subject's environment, oriented such that the lens 20 of the optical device 12 is generally directed towards the eye E and the facial region F of the subject. When the subject is a pilot, the operation phase is defined as the duty time during which the pilot is operating the aircraft, both on the ground and during the flight. In the operation phase, the cognitive capacity detection apparatus 10 is affixed proximate the instrument panel of the aircraft, oriented such that the lens 20 is generally directed at the eye E and the facial region F of the subject. During operation, the cognitive capacity detection device 10 generates a series of operating cognitive capacity scores as described previously while the user is engaged in a fatiguing operation, procedure, or activity. When the user is a pilot, the fatiguing operation is controlling an aircraft in flight. The operating cognitive capacity scores are then compared to the rested cognitive capacity score and when the difference between the two cognitive capacity scores is appropriately large, the cognitive capacity detection device 10 triggers an alert, indicating to the user a possible onset of fatigue, of decreased cognitive capacity, or an impending but not yet present decreased cognitive capacity. In an embodiment, a sequence of the operating cognitive capacity scores is processed by a moving average algorithm or any other filtering mechanism that provides a smoothing function to the sequence of operating cognitive capacity scores to reduce the effects of transient artifacts in the signal.

Should the subject receive an alert from the alert system 16 indicating a loss of cognitive capacity at such time as the subject deems his cognitive capacity adequate, the user input device 18 may be activated by the subject, providing an override signal to the processor 14. The override signal is algorithmically combined with the rate of eye closure and the open-to-closed ratio to desensitize the calculation of the cognitive capacity score.

In an embodiment, the cognitive capacity detection system 10 operates in a network environment in which a plurality of cognitive capacity detection systems 10 are in data communication with each other whereby a rested cognitive capacity score generated by one cognitive capacity detection system 10 is available to another cognitive capacity detection system 10 for the operation phase. The rested cognitive capacity score of one user acquired by one cognitive capacity detection system 10 is available via a data communication link to be compared to an operating cognitive capacity score generated by a second cognitive capacity detection system 10, for instance, mounted in the cockpit of an aircraft. The data communication link may be affected by a cellular telephone link although other data communication links may be used to similar effect. In operation, a user may provide to the cognitive capacity detection system 10 affixed in the cockpit of an aircraft a unique identifier and the cognitive capacity detection system 10 is configured to query the network of cognitive capacity detection systems, perhaps associated with an airline, for an associated, timely rested cognitive capacity score. This rested cognitive capacity score is then downloaded into the cockpit-based cognitive capacity detection system 10 for comparisons during the flight to provide an indication of the change in cognitive capacity.

We claim:

1. A cognitive capacity detection apparatus comprising:
an optical device configured to obtain a sequence of images of an eye of a subject and a facial region of said subject proximate said eye;
a processor in data communication with said optical device;
wherein said processor is adapted to analyze said sequence of images to determine a duration of a partially closed period when said eye is partially closed during an eye blink;
wherein said processor is adapted to calculate a rate of closure of said eye blink from said partially closed period;
wherein said processor is adapted to perform a calculation a rate of closure difference between said rate of closure and a rate of closure threshold value; and
an alert system in data communication with said processor and adapted to indicate when said rate of closure difference indicates an increase in mental fatigue.

2. The apparatus as in claim 1, wherein said rate of closure threshold value is obtained from said subject during an alert rested phase.

3. The apparatus as in claim 1, wherein said processor is adapted to analyze said sequence of images to determine the duration an open period when said eye is open, a closed period when said eye is closed, and calculate a ratio of said open period and said closed period and calculate a ratio difference between said ratio and a ratio threshold value.

4. The apparatus as in claim 3, said alert system further adapted to indicate when said ratio difference indicates an increase in mental fatigue.

5. The apparatus as in claim 3, wherein said ratio threshold value is obtained from said subject during an alert rested phase.

6. The apparatus as in claim 1, further comprising a user input device in data communication with said processor and adapted to receive feedback from said subject regarding said subject's self assessment of mental fatigue.

7. The apparatus as in claim 6, wherein said processor is adapted to alter said calculation based on said feedback.

8. The apparatus as in claim 1, wherein said processor, said optical device, and said alert system are affixed to a frame of eyewear.

9. The apparatus as in claim 1, wherein said processor, said optical device, and said alert system are components of a smartphone.

10. The apparatus as in claim 1, wherein said optical device is adapted to detect light in any of visible, infrared, or ultraviolet spectrum ranges or any combination thereof.

11. The apparatus as in claim 1, further comprising a light source positioned to illuminate said eye and said facial region.

12. The apparatus as in claim 1, further comprising an accelerometer removably affixed to a head of said subject, configured to detect head movements of said subject, and in data communication with said processor.

13. A vigilance prediction apparatus comprising:
an imaging device configured to obtain a sequence of images of an eye of a subject and a facial region of said subject proximate said eye;
a processor in data communication with said imaging device;
wherein said processor is adapted to analyze said sequence of images to determine the duration of a partially closed period when said eye is partially closed during an eye blink;
wherein said processor is adapted to calculate a rate of closure of said eye blink from said partially closed period;
wherein said processor is adapted to perform a calculation a rate of closure difference between said rate of closure and a rate of closure threshold value; and
an alert system in data communication with said processor and adapted to indicate when said rate of closure difference indicates that an increase in mental fatigue will occur within a set time period.

14. The apparatus as in claim 13, wherein said rate of closure threshold value is obtained from said subject during an alert rested phase.

15. The apparatus as in claim 13, wherein said processor is adapted to analyze said sequence of images to determine the duration an open period when said eye is open, a closed period when said eye is closed, and calculate a ratio of said open period and said closed period and calculate a ratio difference between said ratio and a ratio threshold value.

16. A method of determining onset of mental fatigue in a subject, the method comprising:
acquiring a series of images with an optical device of an eye and a facial region of a subject, the facial region proximate said eye;
measuring from said series of images a duration of a partially closed period when said eye is partially closed during an eye blink;
calculating a rate of closure of said eye blink based on said partially closed period;
calculating a rate of closure difference between said rate of closure and a rate of closure threshold value; and
enunciating an alert when said rate of closure difference is indicative of an increase in mental fatigue.

17. The method of claim 16, the method further comprising:
measuring from said series of images the duration of an open period when said eye is open, a closed period when said eye is closed;
calculating a ratio of said open and said close period;
calculating a ratio difference between said ratio and a ratio threshold value; and
enunciating an alert when any of said ratio difference, said rate of closure difference, or a combination of these differences is indicative of an increase in mental fatigue.

18. A method of predicting an onset of mental fatigue in a subject, the method comprising:
acquiring a series of images with an optical device of an eye and a facial region of a subject, the facial region proximate said eye;
measuring from said series of images a duration of a partially closed period when said eye is partially closed during an eye blink;
calculating a rate of closure of said eye blink based on said partially closed period;
calculating a rate of closure difference between said rate of closure and a rate of closure threshold value; and
enunciating an alert when said rate of closure difference indicates that an increase in mental fatigue will occur within a time period.

19. The method of claim 16, the method further comprising:
measuring from said series of images the duration of an open period when said eye is open, a closed period when said eye is closed;
calculating a ratio of said open and said close period;
calculating a ratio difference between said ratio and a ratio threshold value; and
enunciating an alert when any of said ratio difference, said rate of closure difference, or a combination of these differences indicates that an increase in mental fatigue will occur within a time period.

20. The method of claim 18 further comprising acquiring said series of images prior to conducting an activity.
